(19) United States
(12) Patent Application Publication
(10) Pub. No.: US 2014/0241131 A1
(43) Pub. Date: Aug. 28, 2014

(54) Electronic Timepiece

(71) Applicant: Seiko Epson Corporation, Tokyo (JP)

(72) Inventor: Katsuyuki Honda, Nagano-ken (JP)

(73) Assignee: Seiko Epson Corporation, Tokyo (JP)

(21) Appl. No.: 14/188,074

(22) Filed: Feb. 24, 2014

Related U.S. Application Data
(60) Provisional application No. 61/770,522, filed on Feb. 28, 2013.

(30) Foreign Application Priority Data
Mar. 7, 2013 (JP) 2013-045079

(51) Int. Cl. G04C 10/02; G04R 20/02

(52) U.S. Cl. CPC G04C 10/02; G04R 20/02
USPC 368/47; 368/205

(57) ABSTRACT

An electronic timepiece includes a light-transmitting dial; a solar panel which is arranged on a side opposite to a display surface of the dial; and a secondary battery to which power generated by the solar panel is charged. The solar panel is divided into seven or more solar cells and the respective solar cells are connected to one another in series. Since seven or more solar cells are connected in series, a lithium ion secondary battery whose electromotive voltage is high can be charged. Accordingly, a need for charging by means of an external battery charger can be eliminated and a wristwatch capable of internally having a device requiring larger current consumption such as a receiving device can be provided.

### BACKGROUND

1. Technical Field

The present invention relates to an electronic timepiece having a solar cell, and particularly to an electronic timepiece having a device requiring large current consumption, such as a receiving device of a satellite signal and a wireless communication device.

2. Related Art

An electronic timepiece has been known which performs positioning or time correction by receiving a satellite signal transmitted from a Global Positioning System (GPS) satellite (for example, refer to JP-A-2009-168620).

The electronic timepiece of a wristwatch type disclosed in JP-A-2009-168620 internally has a receiving device for receiving a satellite signal and a cell for operating a motor which drives hands. In this case, the receiving device requires significantly larger current consumption as compared to the motor which drives the hands.

Therefore, a silver oxide battery used in the wristwatch in the related art has greater internal resistance of the cell, and thus the wristwatch internally having the receiving device cannot be commercialized. Therefore, in the electronic timepiece disclosed in JP-A-2009-168620, the cell having small internal resistance such as a lithium ion secondary battery is used.

In JP-A-2009-168620, the lithium ion secondary battery is charged by using an external battery charger.

In a charging method of using the external battery charger, charging is available only in a place where the external battery charger is installed, for example, only at home. Therefore, in the electronic timepiece worn and used by a user, particularly such as the wristwatch, there has been a problem of degraded convenience.

In addition, one type of power supply devices which can be used in the electronic timepiece is a solar panel.

However, the lithium ion secondary battery requires a high electromotive voltage of the cell, thereby causing a problem in that the charging is not yet available by the solar panel which has been used in the wristwatch so far.

This problem is not limited to the electronic timepiece which internally has the receiving device of the satellite signal. The problem is common to the electronic timepiece which internally has a device requiring large current consumption, such as a wireless communication device which performs wireless communication with smartphones or mobile phones.

### SUMMARY

An advantage of some aspects of the invention is to provide an electronic timepiece which has a device requiring larger current consumption, and which can eliminate a need for charging by means of an external battery charger and which does not need battery exchange.

An aspect of the invention is directed to an electronic timepiece including a light-transmitting dial; a solar panel which is arranged on a side opposite to a display surface of the dial; and a secondary battery to which power generated by the solar panel is charged. The solar panel has seven or more solar cells and the solar cells are connected to one another in series.

In the electronic timepiece of the aspect of the invention, the solar panel has seven or more solar cells and the respective solar cells are connected to one another in series. An electromotive voltage of one solar cell is approximately 0.6 V or higher. Therefore, if seven or more solar cells are connected to one another in series, that is, if the solar cells have seven or more stages, it is possible to obtain the electromotive voltage of approximately 0.6 V×7 stages=approximately 4.2 V or higher.

In contrast, when the solar cells have six stages or fewer, only the electromotive voltage of approximately 0.6 V×6 stages=approximately 3.6 V or lower is obtained.

Accordingly, when the solar cells have six stages or fewer, it is not possible to charge the lithium ion secondary battery in which the electromotive voltage is approximately 4.2 V. In contrast, according to the aspect of the invention, it is possible to charge the lithium ion secondary battery in which the electromotive voltage is approximately 4.2 V.

Since the lithium ion secondary battery can be charged by the solar panel in this manner, it is possible to eliminate a need for charging by means of an external battery charger, and additionally it is possible to eliminate a need for battery exchange. Furthermore, the electronic timepiece according to the aspect of the invention can use the lithium ion secondary battery as a power source. Therefore, the electronic timepiece can internally have a device requiring large current consumption, such as GPS receiving devices (GPS modules) or wireless communication modules.

Here, it is preferable that the solar panel has eight solar cells or fewer. That is, it is preferable that the solar panel has seven or eight solar cells and the respective solar cells are connected to one another in series.

Portable electronic timepieces such as a wristwatch and a pocket watch have restrictions on a size of a housing (case) and thus cannot be increased in size by very much. For this reason, there are also restrictions on a size of the dial or the solar panel, thereby usually restricting the size to be approximately 30 mm to 40 mm or shorter in diameter.

In the solar panel having the above-described size, if the solar cells are increased to nine or more in number, an area of one solar cell is very small. If the area of the solar cell becomes small, a power generation current is decreased. Therefore, it is not possible to ensure current consumption required for driving the electronic timepiece which internally has various devices.

Furthermore, if the solar cells are increased to nine or more in number, in some cases, the electromotive voltage generated when light of high illuminance such as sunlight is directly emitted to the solar panel may exceed a withstand voltage of electronic elements or electronic devices which are used in a circuit of the electronic timepiece. Therefore, if the withstand voltage is raised for the electronic elements or the electronic devices, the current consumption thereof is increased.

In contrast, as in the aspect of the invention, if the number of the solar cells is eight or fewer, that is, if the solar cells have either seven or eight stages, it is possible to ensure the area of the solar cells to some extent in the solar panel to be incorporated in the portable electronic timepiece such as the wristwatch. Thus, it is possible to ensure the current consumption required for driving the electronic timepiece. In addition, it is possible to prevent the electromotive voltage from being raised very high when the light of high illuminance is emitted to the solar panel. Further, it is also possible to prevent the electromotive voltage from exceeding the withstand voltage of the electronic elements or the electronic devices. Therefore, there is no need to use the electronic elements or the electronic devices which have a high withstand voltage, thereby enabling the current consumption to be reduced.

In addition, it is preferable that the respective solar cells are formed in a fan shape from a center to an outer periphery of a surface of the solar panel.

According to this configuration, for example, when the solar panel is formed in a disk shape, the respective solar cells are formed in the fan shape. Then, if center angles of the respective solar cells are set to be substantially the same angle, the area of the solar cells can easily be made be uniform. The fan shape includes a substantially fan shape such as a shape in which a corner of a fan shape is rounded off.

Furthermore, if the electronic timepiece is worn on the wrist, a portion of the solar panel may be hidden by a sleeve of clothes in some cases. Even in this case, if the light is emitted to at least a half of the solar panel, the light is transmitted to a portion of the entire solar cells which are formed in the fan shape from the center of the solar panel. Therefore, there are no solar cells in which the light is not transmitted thereto and thus a power generation current amount is zero. The solar panel in which the solar cells are connected to one another in series can output the generated power corresponding to a light receiving area.

In addition, it is preferable that the respective solar cells have the same area as one another.

Here, the meaning that the respective solar cells have the same area includes the case where the respective solar cells have the substantially same area, for example, the case where the areas of the respective solar cells fall within ±10% of an average area of all the solar cells.

If the respective solar cells are made substantially the same area, a current value is most increased when the respective solar cells are connected to one another in series and thus it is possible to improve output characteristics of the solar panel. That is, when the light is emitted to an entire surface of the solar panel, an output current of the solar panel is restricted to a current value of the solar cell having the smallest light receiving area among the respective solar cells connected to one another in series. Accordingly, if the respective solar cells have substantially the same area, it is possible to maximize the output current of the solar panel.

In addition, it is preferable that the respective solar cells have the same value calculated by multiplying the area of each of the respective solar cells by a light transmittance of a region disposed on the surface of each of the respective solar cells in the dial as one another.

A power generation amount of each of the solar cells is proportional to the value which is calculated by multiplying the light receiving area by irradiance on the cell surface. Since the light transmitted through the dial reaches the solar cell, the irradiance varies depending on the transmittance in the dial. The dial has some components which do not allow the light to be transmitted therethrough, such as an index. Thus, the transmittances of the regions corresponding to the respective solar cells are different from one another. Accordingly, in a region where the transmittance is low due to arrangement of an index, a scale or a sub-dial, the light receiving area of the solar cell is made large, and in a region where the transmittance is high, the light receiving area of the solar cells is made small. In this manner, if the values calculated by multiplying the light receiving area of the respective solar cells by the transmittances of the regions through which the light received by the respective solar cells are transmitted in the dial are made the same as one another, the power generation amount can also be uniform in the respective solar cells, thereby enabling the power generation amount to be most increased in the solar panel. In addition, the term “same” includes the term “substantially same”.

Furthermore, it is preferable that the respective solar cells are formed to match a designed shape of the dial.

If the respective solar cells are formed to match the designed shape of the sub-dial to be disposed in the dial and the shapes of the respective solar cells are matched with the designed shape, division lines of the respective solar cells are not conspicuous by matching the design of the dial. Therefore, it is possible to improve the design of the dial. In particular, in the electronic timepiece, the design of the dial is an important element for improving decorative elements of a product. Therefore, it is possible to provide an electronic timepiece having excellent design.

Furthermore, it is preferable that the electronic timepiece further includes a receiving unit which receives a satellite signal transmitted from a satellite; a time display unit which displays a time; and a time correction unit which acquires time information acquired from the received satellite signal and corrects the time to be displayed on the time display unit.

According to the aspect of the invention, the time is corrected by using the time information from the received satellite signal. Therefore, it is possible to improve accuracy of the time to be displayed.

### BRIEF DESCRIPTION OF THE DRAWINGS

The invention will be described with reference to the accompanying drawings, wherein like numbers reference like elements.

FIG. 1 is a front view illustrating an electronic timepiece according to the invention.

FIG. 2 is a schematic cross-sectional view of an electronic timepiece.

FIG. 3 illustrates a surface of a solar panel.

FIG. 4 is a graph illustrating output characteristics of a solar cell.

FIG. 5 is a graph illustrating output characteristics of a solar panel.

FIG. 6 is a block diagram illustrating a configuration of an electronic timepiece.

FIG. 7 is a block diagram illustrating a configuration of a storage device.

FIG. 8 is a flowchart illustrating a receiving process in an electronic timepiece.

FIG. 9 is a flowchart illustrating a receiving process in a positioning mode.

FIG. 10 is a schematic diagram illustrating a surface of a solar panel according to a modification example of the invention.

FIG. 11 is a schematic diagram illustrating a surface of a solar panel according to another modification example of the invention.

### DESCRIPTION OF EXEMPLARY EMBODIMENTS

Hereinafter, specific embodiments of the invention will be described with reference to the drawings.

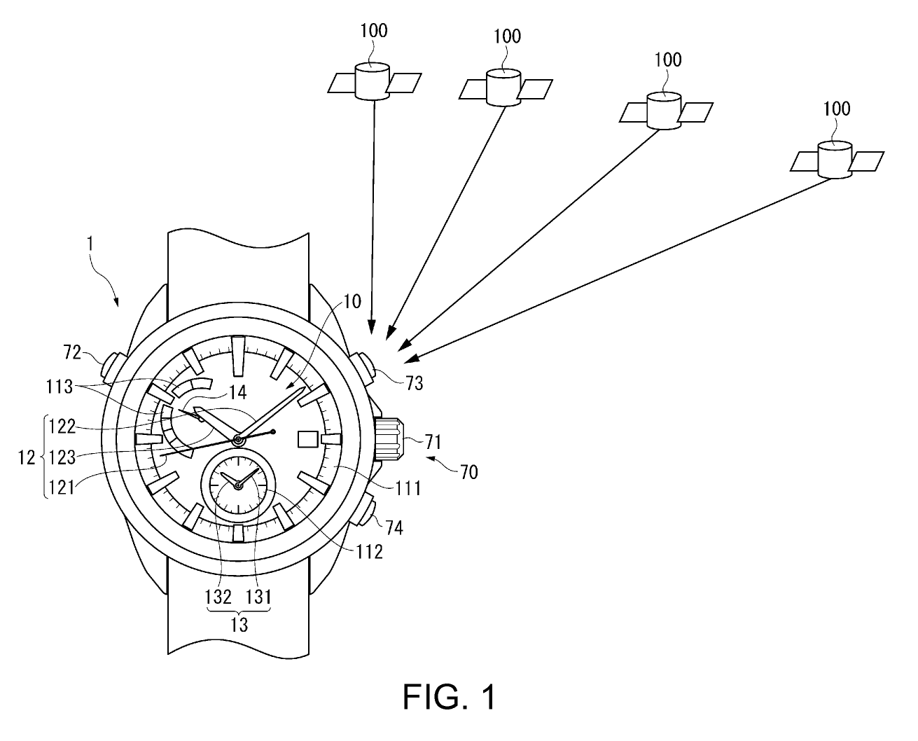

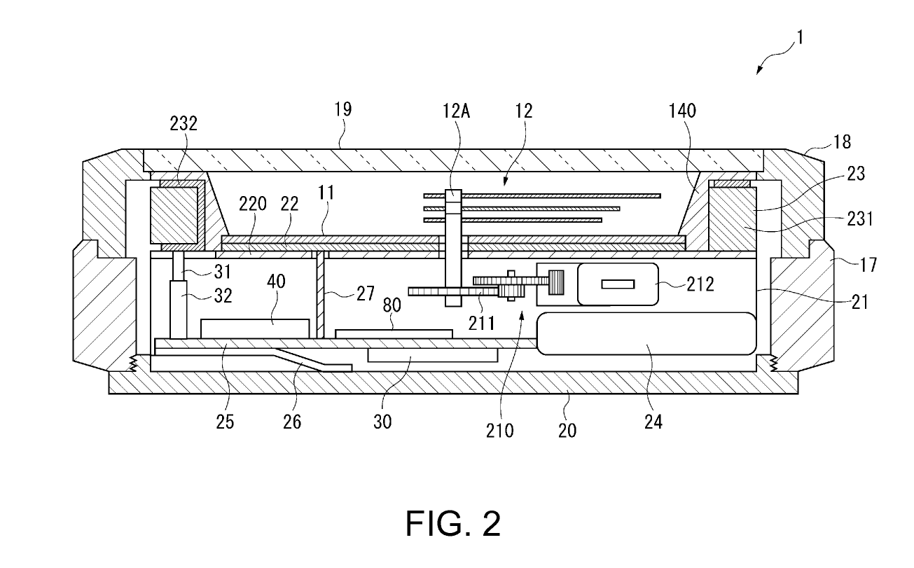

FIG. 1 is a front view illustrating an electronic timepiece 1 according to an embodiment of the invention, and FIG. 2 is a schematic cross-sectional view of the electronic timepiece 1.

As illustrated in FIG. 1, the electronic timepiece 1 receives a satellite signal from at least one GPS satellite 100 out of multiple GPS satellites 100 orbiting the earth in a predetermined orbit in the sky and acquires time information. The electronic timepiece is configured to calculate positioning information by receiving the satellite signal from at least three GPS satellites 100. The GPS satellite 100 is an example of a positioning information satellite, and multiple GPS satellites 100 are present in the sky over the earth. Approximately 30 GPS satellites 100 are currently orbiting the earth.

### Electronic Timepiece

The electronic timepiece 1 is a wristwatch which a user wears on the user's wrist, and includes a display device 10 that displays time or the like and an input device 70.

### Display Device

The display device 10 includes a dial 11, first hands 12, second hands 13 and an indicator hand 14.

The dial 11 is mostly formed of nonmetallic materials to which light and microwave of 1.5 GHz band are likely to be transmitted (for example, plastic or glass).

The dial 11 includes a main dial 111 corresponding to the first hands 12, a sub-dial 112 corresponding to the second hands 13, and a scale 113 corresponding to the indicator hand 14.

The first hands 12 are disposed on a side of the main dial 111. The first hands 12 include a second-hand 121, a minute hand 122 and an hour hand 123. The first hands 12 and the main dial 111 configure a basic timepiece which displays a first time.

The second hands 13 are disposed on a side of the sub-dial 112. The second hands 13 include a minute hand 131 and an hour hand 132. The second hands 13 and the sub-dial 112 configure a minor timepiece which displays a second time.

Accordingly, the electronic timepiece 1 of the present embodiment includes a dual time function which can display the first time and the second time.

The indicator hand 14 is disposed on the side of the main dial 111, and indicates various information items such as a remaining energy level (battery level).

The side of the electronic timepiece 1 facing the wrist side when a user wears the electronic timepiece 1 on the user's wrist is referred to as a rear side and the opposite side thereto is referred to as a surface side. In addition, the surface side of the dial 11 is also referred to as a display surface side.

The hands 12 and 13 and the indicator hand 14 are driven by a step motor via gears. In the present embodiment, there are provided a step motor for driving the minute hand 122 and the hour hand 123 of the first hands 12, a step motor for driving the second-hand 121, a step motor for driving the indicator hand 14, and a step motor for driving the second hands (minute hand 131, hour hand 132). Furthermore, it is preferable to dispose a step motor for driving a date indicator when the date indicator is provided.

### Input Device

The input device 70 includes a crown 71 and three buttons 72, 73 and 74. If the input device 70 is operated, a process is executed according to the manual operation.

Specifically, if the crown 71 is shifted down by one stage, the second hands 13 can be manually corrected. In this state, if the buttons 73 and 74 are pressed, the second hands 13 are moved.

In addition, if the crown 71 is shifted down by two stages, the first hands 12 can be manually corrected. In this state, if the buttons 73 and 74 are pressed, the first hands 12 are moved.

If the button 72 is pressed, a process such as cancellation of various operation modes and a stop of a receiving process is executed according to a situation.

If the button 73 is pressed for a first setting period of time (for example, three seconds or longer, shorter than six seconds), a manual receiving process (compulsory receiving process) is executed in a timing mode. In addition, if the button 73 is pressed for a second setting period of time (for example, six seconds or longer) which is longer than the first setting period of time, a manual receiving process (compulsory receiving process) is executed in a positioning mode. Furthermore, if the button 73 is pressed for a period of time shorter than the first setting period of time (for example, shorter than three seconds), a result display process for displaying a result of the previous receiving process is performed.

If the button 74 is pressed, a process is executed in which setting of the time zone is indicated by the second-hand 121.

The processes executed when the respective buttons 72, 73 and 74 are pressed are not limited to the above description, but may be appropriately set according to functions of the electronic timepiece 1.

### Structure of Electronic Timepiece

As illustrated in FIG. 2, the electronic timepiece 1 includes an outer case 17 made of a metal such as stainless steel (SUS) or titanium. The outer case 17 is formed in a substantially cylindrical shape. A surface glass 19 for covering an opening is attached to the opening of a surface side of the outer case 17 via a bezel 18. The bezel 18 is made of a non-metallic material such as ceramic so as to improve a receiving performance for satellite signals. A case back 20 is attached to an opening of a rear side of the outer case 17. The dial 11, a movement 21, a solar panel 22, a GPS antenna 23, and secondary battery 24 are arranged inside the outer case 17.

The movement 21 includes a drive mechanism 210 which drives the display device 10 of the first hands 12, the second hands 13 and the indicator hand 14. The drive mechanism 210 is configured to include step motors, a train wheel 211 and a drive circuit which drives the step motors. The step motor is configured to have a motor coil 212, a stator and a rotor, and drives the first hands 12 via the train wheel 211 or an oscillating axle 12A.

A circuit board 25 is arranged in the case back 20 side of the movement 21.

A receiving device 30 which processes the satellite signal received by the GPS antenna 23, a control device 40 which performs various controls such as drive controls for the receiving device 30 or the step motors, a charging circuit 80 which charges power generated by the solar panel 22 to the secondary battery 24 are attached to the circuit board 25. The receiving device 30, and the control device 40 and the charging circuit 80 are driven by the power supplied from the secondary battery 24.

### Solar Panel

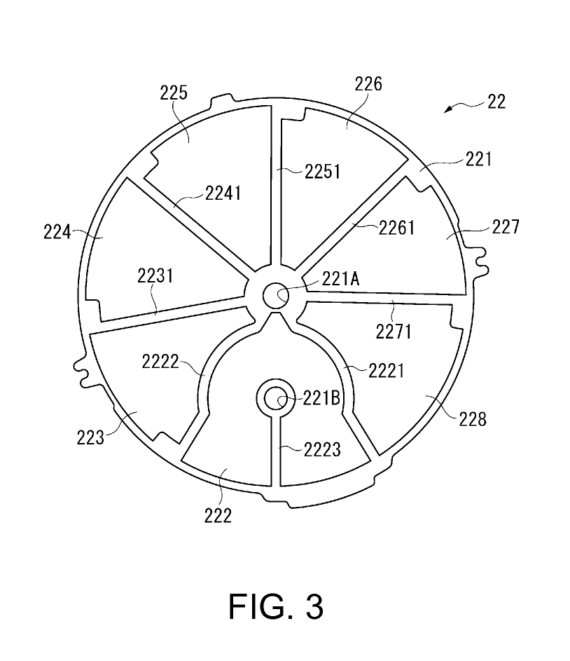

The solar panel 22 is a photovoltaic power generation element which performs photovoltaic power generation for converting light energy into electrical energy. As illustrated in FIG. 3, the solar panel 22 includes a substrate 221 having a substantially circular shape in a plan view, seven solar cells 222 to 228 which are light receiving units formed on the surface side of the substrate 221, and electrodes (not illustrated, positive electrode and negative electrode) which are formed on the rear side of the substrate 221.

The surface side of the solar panel 22 is referred to as the light receiving surface side.

The substrate 221 is configured to have an insulating material such as a film of synthetic resin. The solar cells 222 to 228 are configured to stack a metal electrode layer, a semiconductor layer, an insulating layer, a wiring electrode layer and a light-transmitting sealing resin layer on the surface of the substrate 221.

Accordingly, the solar panel 22 of the present embodiment is a solar cell of a film type. Therefore, the solar panel 22 is supported by a solar panel support substrate 220. As the solar panel 22, those which have a substrate made of glass may be used. In this case, the solar panel support substrate 220 can be made unnecessary.

Seven solar cells 222 to 228 are solar panels made of amorphous silicon. However, the material of the solar panels is not limited to the amorphous silicon. Any one may be acceptable which can be used as the solar cell.

The solar cells 222 to 228 are formed in a fan shape from a center portion of the surface of the solar panel 22, that is, a portion of a center hole 221A to which a rotation axle 12A of the first hands 12 is inserted, to an outer periphery in the solar panel 22. That is, the solar cells 222 to 228 have a shape surrounded by two line portions facing from the portion of the center hole 221A to the outer periphery of the solar panel 22, a first arcuate portion along the center hole 221A and a second arcuate portion along the outer periphery of the solar panel 22.

The solar cell 222 is formed in a substantially fan shape to match a position and a shape of the sub-dial 112. That is, the solar cell 222 is formed at six o'clock side of the center hole 221A in the solar panel 22. The solar cell 222 is divided from the other adjacent solar cells 228 and 223 by division lines 2221 and 2222 which extends from the center hole 221A to the outer periphery of the substrate 221. The division lines 2221 and 2222 are configured to have a portion having no solar cell 222 in the substrate 221, that is, a portion to which the substrate 221 is exposed. The division lines 2221 and 2222 include an arcuate portion which is curved along the outer periphery of the sub-dial 112 and a straight portion. The respective division lines are radially formed from the center portion of the surface of the solar panel 22, that is, the portion of the center hole 221A to which the rotation axle 12A of the first hands 12 is inserted, to the outer periphery in the solar panel 22.

A hole 221B to which the rotation axle of the second hands 13 is inserted is formed in the center portion of the solar cell 222. A division line 2223 is disposed around the hole 221B, and the division line 2223 is extended to the outer periphery of the solar panel 22.

The solar cell 223 is divided from the solar cell 222 and the solar cell 224 by the division line 2222 and a division line 2231 which extends from the center hole 221A to the outer periphery of the substrate 221.

The solar cell 224 is divided from the solar cell 223 and the solar cell 225 by the division line 2231 and a division line 2241 which extends from the center hole 221A to the outer periphery of the substrate 221.

The solar cell 225 is divided from the solar cell 224 and the solar cell 226 by the division line 2241 and a division line 2251 which extends from the center hole 221A to the outer periphery of the substrate 221.

The solar cell 226 is divided from the solar cell 225 and the solar cell 227 by the division line 2251 and a division line 2261 which extends from the center hole 221A to the outer periphery of the substrate 221.

The solar cell 227 is divided from the solar cell 226 and the solar cell 228 by the division line 2261 and a division line 2271 which extends from the center hole 221A to the outer periphery of the substrate 221.

The solar cell 228 is divided from the solar cell 227 and the solar cell 222 by the division line 2271 and the division line 2221.

The respective solar cells 222 to 228 are arranged according to the design of the dial 11, for example, the design for a shape and a position of the sub-dial 112, the scale 113 and each element such as a date window which is disposed in the dial 11 when a date indicator is further disposed. Therefore, the area of the respective solar cells 222 to 228 is somewhat different from one another, but is set to have the substantially uniform power generation amount when the light is actually emitted thereto. That is, the solar cells 222 to 228 may have a portion to which the light is not emitted due to components arranged on the dial 11, such as the index (number or bar indicating the time), the outer peripheral portion of the sub-dial 112 and the scale 113 of the indicator hand 14. Depending on the arrangement place or the area of the components which is a design element as described above, transmittances of regions of the dial 11 which oppose the respective solar cells 222 to 228 are different from one another.

Therefore, the values calculated by multiplying the areas of the respective solar cells 222 to 228 by the transmittances in the respective regions of the dial 11 through which the light emitted to the respective solar cells 222 to 228 is transmitted are set to be approximately the same as one another.

For example, the area of the solar cell 222 is assumed to be S1 and the transmittance of the region corresponding to the solar cell 222 in the dial 11 is assumed to be T1. The region corresponding to the solar cell 222 in the dial 11 can be set to be a region overlapped with the solar cell 222 in the dial 11, for example when the electronic timepiece 1 is viewed in a plan view, that is, when viewed from a direction perpendicular to the dial 11. The area of the region may be the same as the area of the region of the solar cell 222, or may be slightly different from one another. Similarly, each area of the solar cells 223 to 228 is assumed to be S2 to S7, and the transmittance of the region corresponding to the solar cells 223 to 228 in the dial 11 is assumed to be T2 to T7. In this case, the value is set to satisfy S1×T1≈S2×T2≈S3×T3≈S4×T4≈S5×T5≈S6×T6≈S7×T7. For example, the value calculated by multiplying the above-described respective areas S1 to S7 by the transmittance T1 to T7 may be set to fall within a range of ±10% or less with respect to an average value of the multiplied value.

Output terminals of seven solar cells 222 to 228 are connected to one another in series. Accordingly, an output voltage V of the solar panel 22 is obtained by adding each of output voltages V1 to V7 of the solar cells 222 to 228 in seven stages.

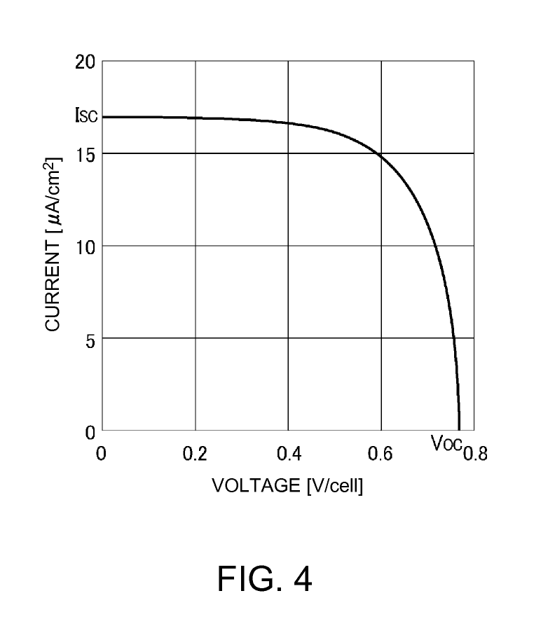

Here, FIG. 4 illustrates an example of output characteristics of a unit cell which can be used as the solar cells 222 to 228 of the present embodiment. FIG. 4 illustrates the characteristics when a temperature is 25° C. and FL500 Lux (fluorescent lamp of 500 Lux) is used as a light source. In this case, an open circuit voltage Voc is 0.78 V/cell and a short circuit current Isc is 17.0 μA/cm². The solar cells 222 to 228 are not limited to those having the characteristics in FIG. 4.

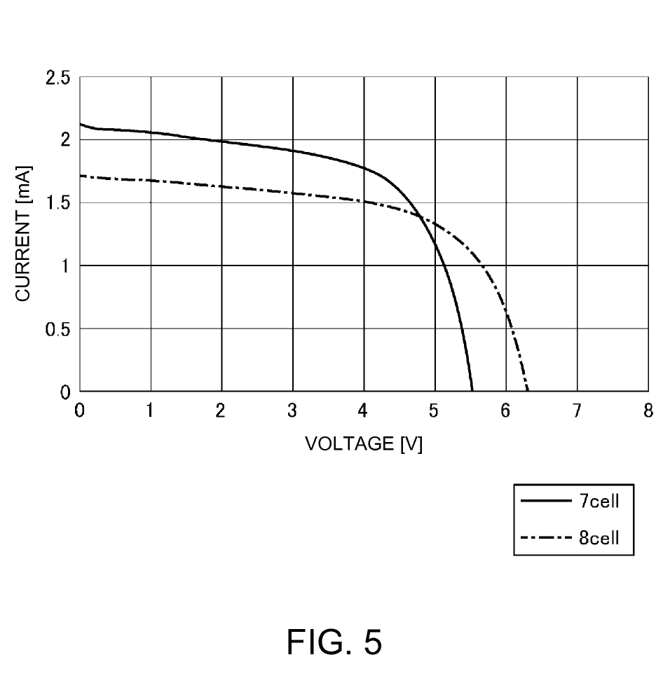

FIG. 5 illustrates an example of the output characteristics of the solar panel 22 which uses the seven-stage solar cells 222 to 228 having the above-described characteristics.

As illustrated by a solid line in FIG. 5, since the seven-stage solar cells 222 to 228 are connected to one another in series, the open circuit voltage is approximately 0.78 V×7=approximately 5.46 V. When the solar cells are connected to one another in eight-stage series, the open circuit voltage is approximately 0.78 V×8=approximately 6.24 V as illustrated by a dashed line in FIG. 5.

As illustrated in FIG. 2, the solar panel 22 is supported by a solar panel support substrate 220. For example, the solar panel support substrate 220 is a conductive substrate having a width of 0.1 mm for example, which is formed of a metallic material such as brass (BS), stainless steel (SUS) and titanium alloy. In this manner, the solar panel support substrate 220 functions as a part of the GPS antenna 23 after having a current distribution the same as that of the GPS antenna 23 arranged in close proximity.

The solar panel support substrate 220 is incorporated into the outer case 17 so as not to be in contact therewith. That is, the solar panel support substrate 220 is arranged so that an outer peripheral edge thereof is apart from and is not in contact with an inner peripheral surface of the outer case 17.

The dial 11 and the solar panel 22 are formed so that each outer diameter matches an inner diameter of dial ring 140 and each outer periphery is hidden by the dial ring 140. Accordingly, the solar panel support substrate 220 is not visible from outside. In addition, an outer dimension of the solar panel support substrate 220 is adapted to be larger than the solar panel 22 and the dial 11, and is enlarged to a lower surface position of the GPS antenna 23.

### GPS Antenna

The GPS antenna 23 includes an annular dielectric substrate 231 having a rectangular cross-sectional shape, and is a ring antenna, a surface of which has an antenna electrode 232.

The dielectric substrate 231 is adapted to shorten a wavelength of radio waves and can be configured to have so-called micarex (∈r=6.5 to 9.5), glass (∈r=5.4 to 9.9) and diamond (∈r=5.68) which are ceramics mainly composed of alumina (∈r=8.5) or ceramics mainly composed of mica.

The antenna electrode 232 is formed linearly and integrally with the dielectric substrate 231 by printing conductive metallic elements such as copper or silver on a surface of the dielectric substrate 231, or by bonding a conductive metallic plate such as silver or copper to the surface of the dielectric substrate 231. The antenna electrode 232 may be formed by forming patterns on the surface of the dielectric substrate 231 by means of electroless plating.

A connection pin 31 is in contact with the antenna electrode 232. The connection pin 31 is inserted to a connection base portion 32 having a substantially cylindrical shape. The connection base portion 32 is erected by being connected to a printed circuit on the circuit board 25.

The connection pin 31 and the connection base portion 32 are electrically connected to the receiving device 30 via the printed circuit. In the connection base portion 32, a biasing member such as a coil spring, for example, is disposed in an inner cylindrical portion thereof, and biases the connection pin 31 inserted to the connection base portion 32 against the antenna electrode 232 side. This causes the connection pin 31 to be pressed against a feeding point of the antenna electrode 232. In this manner, even when impact is applied to the electronic timepiece 1 for example, a connection state between the connection pin 31 and the antenna electrode 232 is maintained.

In the present embodiment, the case back 20 made of the conductive material also serves as a ground plate (reflection plate) of the GPS antenna 23. The case back 20 is electrically connected to a ground terminal 26 disposed in the movement 21. The ground terminal 26 is connected to a ground potential of the receiving device 30 of the movement 21. Therefore, the case back 20 is electrically connected to the ground potential of the receiving device 30 via the ground terminal 26, and functions as the ground plate (reflection plate) which reflects the radio waves incident from the surface glass 19 side toward the GPS antenna 23. Since the outer case 17 which has the conductive material and is in contact with the case back 20 is the ground potential, the outer case 17 also functions as the ground plate.

Furthermore, the case back 20 and the outer case 17 are made of the metal. Accordingly, in addition to the function as the ground plate, it is possible to avoid influence on the GPS antenna 23 when the user wears the electronic timepiece 1 on the arm. That is, if the case is a plastic case, a resonance frequency of the GPS antenna 23 is changed by receiving the any influence from the neighboring arm between a wearing state and a non-wearing state. Thus, it is not preferable since there is a difference in performance. However, since the case is made of the metal, it is possible to avoid the influence from the arm by virtue of the shield effect. In the present embodiment, there is little difference in antenna characteristics between the wearing state and the non-wearing state, thereby allowing a stable receiving performance.

### Secondary Battery

The secondary battery 24 is a power supply device of the electronic timepiece 1, and stores power generated by the solar panel 22.

In the electronic timepiece 1, two electrodes of the solar panel 22 and two electrodes of the secondary battery 24 can be respectively and electrically connected to each other by two conductive coil springs 27. When connected, the secondary battery 24 is charged by the photovoltaic power generation of the solar panel 22. In the present embodiment, a lithium ion secondary battery suitable for portable devices is used as the secondary battery 24. However, a lithium polymer battery or other secondary batteries may be used, and alternatively a rechargeable battery different from the secondary battery (for example, capacitance elements) may be used.

The solar panel 22 generates the power in such a manner that the light transmitted through the dial 11 is incident on the solar cells 222 to 228. The current generated by the solar cells 222 to 228 flows from output terminals (electrodes) disposed in the substrate 221 of the solar panel 22, and charges the secondary battery 24 via the conductive coil spring 27 and the charging circuit 80. Since the secondary battery 24 is the lithium ion secondary battery, a high voltage of approximately 4.2 V for example is required for the charging. In the present embodiment, it is possible to ensure a charging voltage of approximately 5.5 V by connecting the seven-stage solar cells 222 to 228 to one another in series. Therefore, the secondary battery 24 can be sufficiently charged.

### Circuit Configuration of Electronic Timepiece

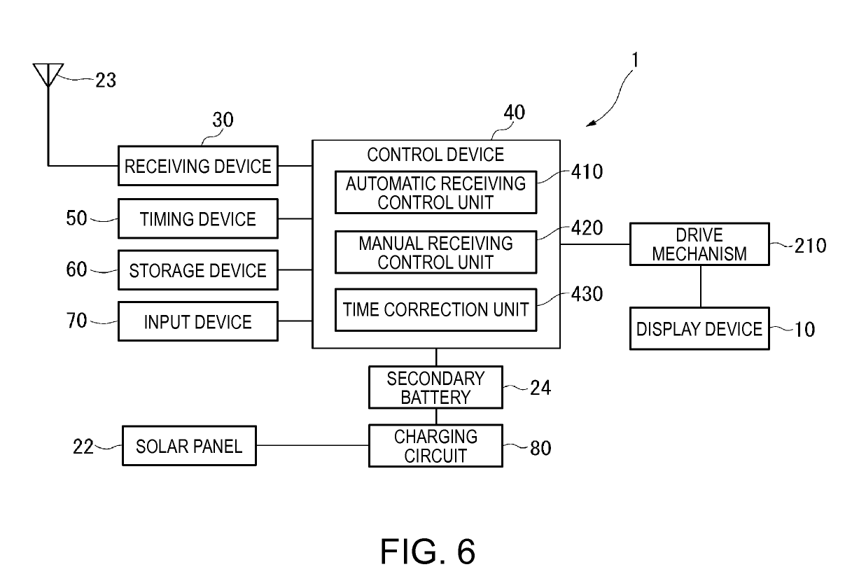

FIG. 6 is a block diagram illustrating a circuit configuration of the electronic timepiece 1. The electronic timepiece 1 includes the receiving device 30, the control device 40, a timing device 50, a storage device 60 and the input device 70. The control device 40 includes an automatic receiving control unit 410, a manual receiving control unit 420 and a time correction unit 430.

### Receiving Device

The receiving device 30 is a load driven by the power stored in the secondary battery 24, and when driven by the control device 40, receives the satellite signal transmitted from the GPS satellite 100 through the GPS antenna 23. Then, when successfully receiving the satellite signal, the receiving device 30 transmits the acquired information such as orbit information and GPS time information to the control device 40. In contrast, when failing to receive the satellite signal, the receiving device 30 transmits information indicating the failure to the control device 40. A configuration of the receiving device 30 is the same as a configuration of a known GPS receiving circuit. Therefore, description thereof will be omitted.

### Timing Device

The timing device 50 includes a quartz crystal resonator driven by the power stored in the secondary battery 24, and updates time data by using a reference signal based on a vibration signal of the quartz crystal resonator.

### Storage Device

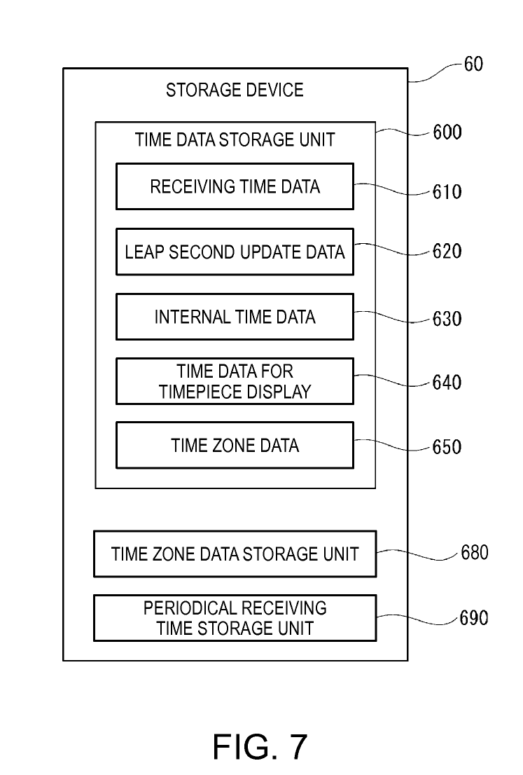

As illustrated in FIG. 7, the storage device 60 includes a time data storage unit 600, a time zone data storage unit 680 and a periodical receiving time storage unit 690.

The time data storage unit 600 stores receiving time data 610, leap second update data 620, internal time data 630, time data for timepiece display 640 and time zone data 650.

The receiving time data 610 stores time information (GPS time) acquired from the satellite signal. The receiving time data 610 is usually updated by the timing device 50 once for every second, and is corrected based on the acquired time information (GPS time) when receiving the satellite signal.

The leap second update data 620 stores at least current leap second data. That is, page 18 in a sub-frame 4 of the satellite signal includes each data of “current leap second”, “update week of the leap second”, “update date of the leap second” and the “leap second after the update”. Among them, in the present embodiment, at least the “current leap second” data is stored in the leap second update data 620.

The internal time data 630 stores internal time information. The internal time information is updated by the GPS time stored in the receiving time data 610 and the “current leap second” stored in the leap second update data 620. That is, Coordinated Universal Time (UTC) is stored in the internal time data 630. When the receiving time data 610 is updated in the timing device 50, the internal time information is also updated.

The time data for timepiece display 640 stores time data where the time zone data (time difference information) of the time zone data 650 is added to the internal time information of the internal time data 630. The time zone data 650 is set by the positioning information obtained when receiving the positioning information in a positioning mode.

The time zone data storage unit 680 associates the positioning information (latitude and longitude) with the time zone data (time difference information) and stores the information. Therefore, when acquiring the positioning information in the positioning mode, the control device 40 can acquire the time zone data based on the positioning information (latitude and longitude).

The time zone data storage unit 680 may store a city name and the time zone data in association with each other. In this case, if the user selects the city name where the user wants to know the local time by operating the input device 70, the control device 40 may search for the city name set by the user from the time zone data storage unit 680 and may acquire the time zone data corresponding to the city name so as to be set in the time zone data 650.

The periodical receiving time storage unit 690 stores periodical receiving time for executing a periodical receiving process using the automatic receiving control unit 410. As the periodical receiving time, time which is successfully and compulsorily received by operating the button 73 previously is stored.

### Control Device

The control device 40 is configured to have a CPU for controlling the electronic timepiece 1. The control device 40 includes the automatic receiving control unit 410 and the manual receiving control unit 420 as a receiving control unit which executes the receiving process by controlling the receiving device 30. In addition, the control device 40 includes the time correction unit 430 which acquires the time information contained in the satellite signal received by the receiving device 30 and which corrects the time timed by the receiving time data 610 using the time information.

### Automatic Receiving Control Unit

The automatic receiving control unit 410 operates the receiving device 30 and performs the receiving process in the timing mode when the time becomes the periodical receiving time set by the periodical receiving time storage unit 690, and when the power generation voltage or the power generation current of the solar panel 22 is equal to or higher than the setting value.

That is, when the timed time, specifically the internal time data 630 becomes the periodical receiving time stored in the periodical receiving time storage unit 690, the automatic receiving control unit 410 operates the receiving device 30. This is referred to as a periodical receiving process.

In addition, when the power generation voltage or the power generation current of the solar panel 22 is equal to or higher than the setting value and thus it is determined that sunlight is emitted to the solar panel 22 outdoors, the automatic receiving control unit 410 operates the receiving device 30. The number of processes for operating the receiving device 30 in the power generation state of the solar panel 22 may be restricted to once a day.

The automatic receiving control unit 410 causes the receiving device 30 to capture at least one GPS satellite 100 and acquires the time information by receiving the satellite signal transmitted from the GPS satellite 100. Then the time correction unit 430 corrects the receiving time data 610 by using the acquired time information when the time information is successfully acquired.

### Manual Receiving Control Unit

The manual receiving control unit 420, when the user presses the button 73 of the input device 70 to perform the compulsory receiving operation, operates the receiving device 30 and performs the receiving process.

At this time, according to the period of time while the button 73 is pressed, the manual receiving control unit 420 performs a process by switching between the receiving process in the timing mode and the receiving process in the positioning mode. The manual receiving control unit 420 performs the receiving process in the timing mode when the button 73 is pressed for the first setting period of time (three seconds or longer, shorter than six seconds), and performs the receiving process in the positioning mode when the button 73 is pressed for the second setting period of time (six seconds or longer).

The manual receiving control unit 420, when performing the receiving process in the timing mode, similar to the automatic receiving control unit 410, causes the receiving device 30 to capture at least one GPS satellite 100 and acquires the time information by receiving the satellite signal transmitted from the GPS satellite 100. Then, when the time information is successfully acquired, the time correction unit 430 corrects the receiving time data 610 by using the acquired time information.

When performing the receiving process in the positioning mode, the manual receiving control unit 420 causes the receiving device 30 to capture at least three GPS satellites 100 (preferably four or more), receives the satellite signal transmitted from each GPS satellite 100, acquires the time information, and further acquires the positioning information by means of calculation. Then, when the positioning information is successfully acquired, the control device 40 acquires time zone data (time difference information) from the time zone data storage unit 680 based on the acquired positioning information (latitude and longitude), and stores the time zone data in the time zone data 650.

For example, since Japanese Standard Time (JST) is nine hours ahead of UTC (UTC +9), when the positioning information acquired in the positioning mode is in Japan, the control device 40 reads out the time difference information (plus nine hours) of Japanese Standard Time from the time zone data storage unit 680 and stores the time difference information in the time zone data 650. Therefore, the time data for timepiece display 640 is the time in which the time zone data is added to the internal time data 630 which is UTC time.

### Operation of Control Device

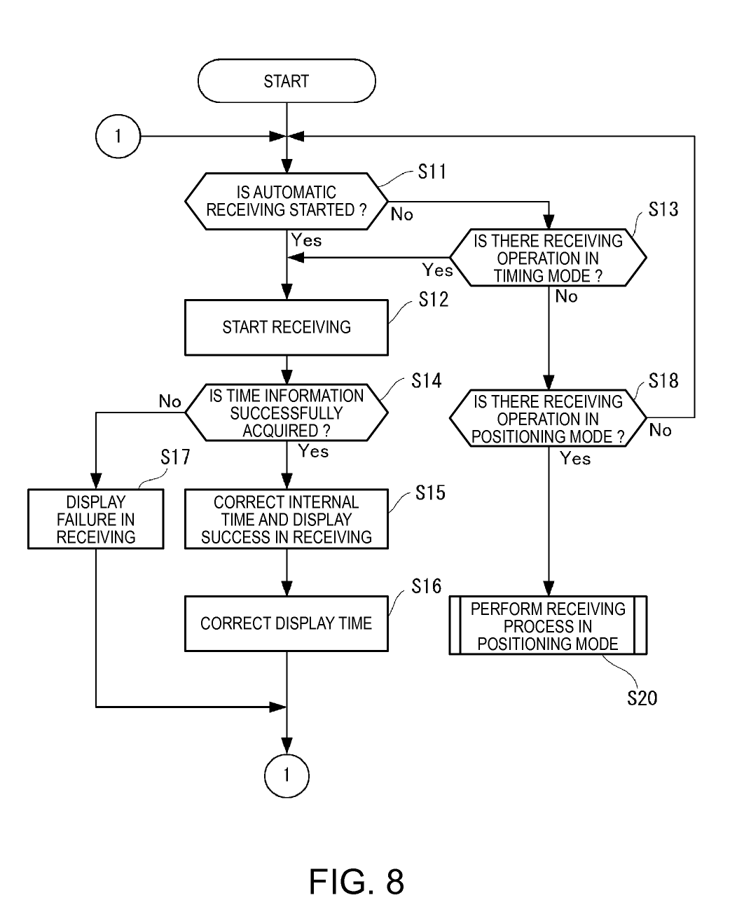

FIG. 8 is a flowchart illustrating the receiving process of the satellite signal of the electronic timepiece 1 according to the present embodiment.

If the receiving process is started, the control device 40 determines whether the process is relevant to a condition for starting the automatic receiving (S11). As described above, when it is the periodical receiving time and when the power generation voltage or current in the solar panel 22 is equal to or higher than the setting value, the control device 40 determines that the process is relevant to the condition for starting the automatic receiving (S11: YES).

When it is determined Yes in S11, the automatic receiving control unit 410 starts the receiving process in the timing mode (S12).

When it is determined No in S11, the manual receiving control unit 420 determines whether or not there is the receiving operation in the timing mode where the button 74 is pressed for the first setting period of time (three seconds or longer, shorter than six seconds) (S13).

When it is determined Yes in S13, the manual receiving control unit 420 starts the receiving process in the timing mode (S12).

### Receiving Process in Timing Mode

If the receiving process in the timing mode is started in S12, the control device 40 determines whether or not the time information is successfully acquired (S14).

The receiving device 30 first performs searching to capture the GPS satellite 100. If the GPS satellite 100 is captured, the receiving device 30 receives the satellite signal and acquires the time information. Since the time information is transmitted at intervals of six seconds, the time information can be received by receiving the satellite signal for six seconds. when the time information can be acquired, the control device 40 determines Yes in S14. In other cases, that is, in the case where the receiving device 30 cannot capture the GPS satellite 100 or in the case where the time information cannot be received, the control device 40 determines that the acquisition of the time information fails (S14: No).

### Correction Process of Internal Time in Timing Mode

When it is determined that the time information is successfully acquired (S14: case of Yes), the control device 40 causes the time correction unit 430 to correct the receiving time data 610 by using the acquired time information, and the internal time data 630 is corrected by being further compensated in the leap second update data 620 (S15). If the internal time data 630 is corrected, the time data for timepiece display 640 is also corrected by the time zone data 650 which is set.

In addition, the control device 40 displays the success in the receiving by moving the second-hand 121 to a predetermined position via the drive mechanism 210 (S15). The display of the success in the receiving is performed for a predetermined period of time, for example, five seconds.

If the internal time data 630 is corrected in S15 and the display of the success in the receiving for the predetermined period of time is completed, the display time using the first hands 12 is also corrected based on the time data for timepiece display 640 (S16). Therefore, in the second hands 13 which are set to be operated independently from the first hands 12, the display time is not corrected in conjunction with the correction of the display time in the first hands 12. However, the second hands 13 may be configured to be corrected in conjunction with the first hands 12.

In contrast, when it is determined No in S14 (in the case where the receiving fails), the control device 40 does not perform the correction process (S15) of the internal time, moves the second-hand 121 to a predetermined position via the drive mechanism 210, and displays that the receiving fails (S17). The display of failure in receiving is also performed for a predetermined period of time, for example, five seconds.

If the processes in S16 and S17 are completed, the control device 40 returns to the process in S11.

### Receiving Process in Positioning Mode

When it is determined No in S13, the control device 40 determines whether or not there is the receiving operation in the positioning mode where the button 74 is pressed for the second setting period of time (six seconds or longer) (S18).

When it is determined No in S18, the control device 40 returns to the process in S11.

In contrast, when it is determined Yes in S18, the control device 40 executes the receiving process in the positioning mode (S20).

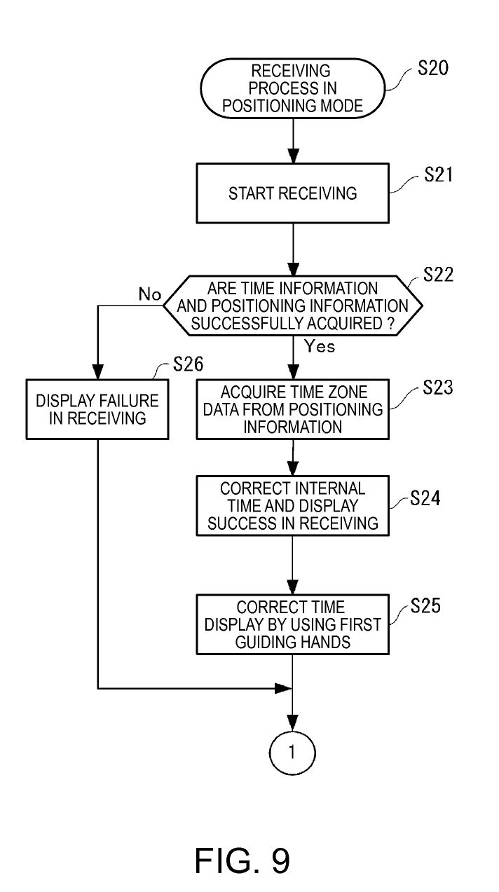

The receiving process in the positioning mode is illustrated in FIG. 9.

The manual receiving control unit 420 of the control device 40 starts the receiving process in the positioning mode (S21).

After the receiving process is started in S21, the control device 40 determines whether or not the time information and the positioning information are successfully received (S22).

### Time Correction Process in Positioning Mode

When determining that the time information and the positioning information are successfully received by the receiving process (S22: case of Yes), the control device 40 acquires the time zone data corresponding to the acquired positioning information from the time zone data storage unit 680 and corrects the time zone data 650 (S23).

In addition, the control device 40 corrects the internal time data 630 by using the acquired time information, moves the second-hand 121 to a predetermined position and displays that the receiving is successful (S24). This display of the success in the receiving is also performed for a predetermined period of time, for example, five seconds. At this time, if the time zone data 650 and the internal time data 630 are corrected, the control device 40 also corrects the time data for timepiece display 640.

If the display of the success in the receiving for the predetermined period of time is completed, the control device 40 corrects the display time using the first hands 12, based on the time data for timepiece display 640 (S25). In this manner, even when travelling to a country having the different time zone by plane or the like, the display time of the first hands 12 can be automatically corrected to the time of the current location (local time).

The second hands 13 which are set to be operated independently from the first hands 12 are not corrected in conjunction with the correction of the first hands 12. Therefore, the second hands 13 can always display the home time.

In contrast, when it is determined No in S22 (in the case where the receiving fails), the control device 40 moves the second-hand 121 to a predetermined position via the drive mechanism 210 and displays that the receiving fails (S26). This display of the failure in the receiving is also performed for a predetermined period of time, for example, five seconds.

If the processes in S25 and S26 are completed, the control device 40 completes the receiving process S20 in the positioning mode, and returns to the process in S11 of FIG. 8. Therefore, until it is determined Yes in either S11, S13 or S18, the control device 40 maintains a standby state where the receiving process has not yet started.

### Advantageous Effect of Embodiment

According to the present embodiment, the following advantageous effect can be obtained.

The solar panel 22 includes seven solar cells 222 to 228 which are divided and connected to one another in series. Accordingly, as compared to the solar panel in which three to five solar cells used in the wristwatch so far are connected to one another in series, it is possible to raise the electromotive voltage generated by the solar panel 22. Therefore, the lithium ion secondary battery 24 which cannot be charged by the solar panel in the related art can be sufficiently charged by using the solar panel 22 of the present embodiment.

Accordingly, it is possible to eliminate a need for charging by means of the external battery charger, and it is possible to eliminate a need for a battery exchange. Therefore, since it is possible to charge the electronic timepiece 1 while in use, the convenience can be improved. Accordingly, it is possible to achieve the electronic timepiece 1 which is excellent in portability and convenience.

Moreover, it is possible to raise the electromotive voltage by disposing a boosting circuit even when three to five solar cells are connected to one another in series. However, since it is not necessary to dispose the boosting circuit in the present embodiment, it is possible to reduce a load of the charging circuit 80 and to reduce the current consumption as compared to the case where the boosting circuit is disposed.

In addition, in the solar panel 22, seven solar cells 222 to 228 are connected to one another in series. Accordingly, as compared to the case where many more solar cells such as nine or more solar cells are disposed and connected to one another in series, it is possible to lower the electromotive voltage. Therefore, there is no need to use the electronic elements or the electronic devices which have the high withstand voltage, thereby enabling the current consumption to be suppressed in the electronic elements or the electronic devices. Therefore, it is possible to extend the duration of the electronic timepiece 1.

Furthermore, the solar panel 22 is divided into seven solar cells 222 to 228. Accordingly, as compared to the case where the solar panel 22 is divided into eight or more solar cells, it is possible to increase the areas of the respective solar cells 222 to 228, and it is possible to increase the power generation amount of the solar panel 22. Therefore, it is possible to ensure the current consumption of the electronic timepiece 1 including the receiving device 30. Accordingly, it is possible to commercialize the electronic timepiece 1 of the wristwatch type which can drive the receiving device 30 receiving the satellite signal by using the power generated in the solar panel 22 and stored in the lithium ion secondary battery 24.

In addition, the respective solar cells 222 to 228 are divided by the division lines which are formed radially from the center of the solar panel 22. Therefore, even when a portion of the solar panel 22 is hidden by the sleeve of clothes and the light is not emitted thereto, if the light is incident on at least a half of the solar panel 22, the light can be emitted to at least a portion of the respective solar cells 222 to 228. Therefore, the solar cells 222 to 228 are not present in which the light is not transmitted and thus the power generation current amount is zero. The solar panel 22 can output the generated power corresponding to the light receiving area.

The dial 11 has the sub-dial 112, the scale 113 and the like. Accordingly, the transmittance of the light is different depending on areas within the dial 11. Here, the values calculated by multiplying the areas of the respective solar cells 222 to 228 by the transmittances in the respective regions opposing the respective solar cells 222 to 228 in the dial 11 are set to be approximately the same as one another. Therefore, the power generation amount can also be uniform in the respective solar cells 222 to 228, thereby enabling the power generation amount to be most increased in the solar panel 22.

Furthermore, the respective solar cells 222 to 228 are divided so as to match the designed shape of the dial 11 such as the sub-dial 112. The division lines 2221 to 2271 of the respective solar cells 222 to 228 are not conspicuous by matching the design of the dial 11. Therefore, it is possible to improve the design of the dial 11, and it is possible to provide the electronic timepiece 1 which has the excellent design.

In addition, in this configuration, the receiving process is performed in the timing mode during the automatic receiving process and the receiving in the positioning mode where the receiving time is longer is executed only when the button 74 is pressed for the second setting period of time. In this manner, the receiving process of the positioning mode is executed only when the user of the electronic timepiece 1 intentionally performs the receiving operation. Therefore, without having to continue the receiving for a long period of time in a state where the satellite signal cannot be received, it is possible to prevent the power from being significantly consumed.

### Another Embodiment

The invention is not limited to the configuration of the respective embodiments. Various modifications can be made within the scope of the invention.

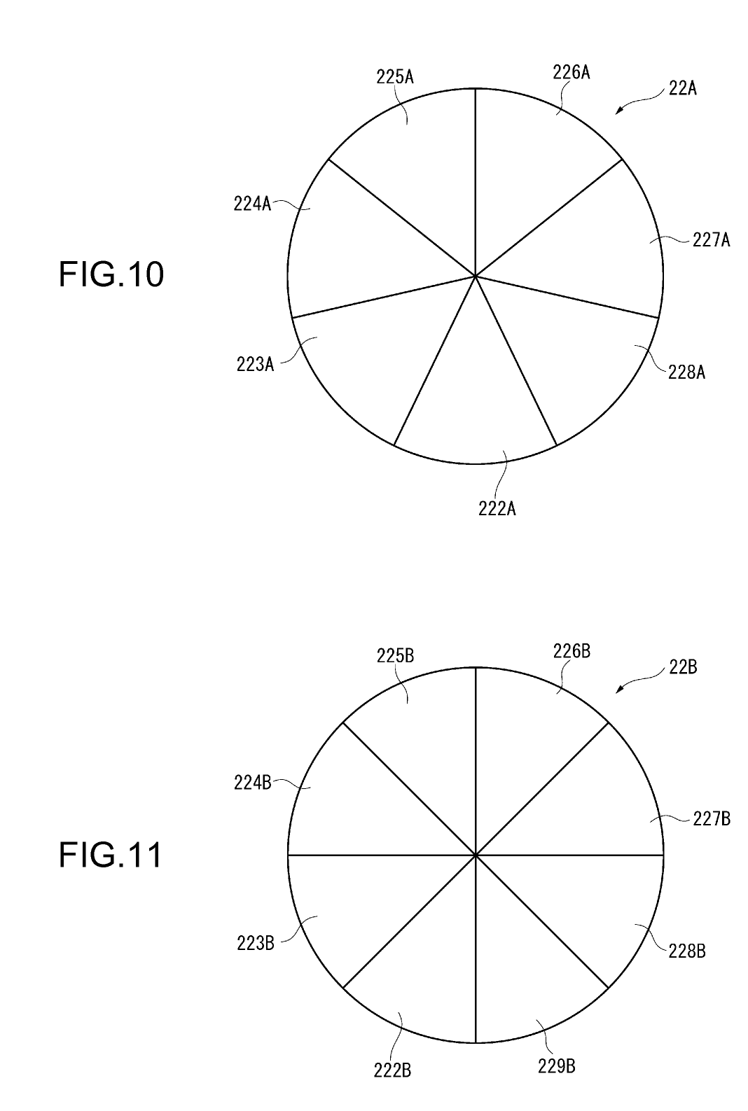

As illustrated in FIG. 10, a solar panel 22A may be used which is divided into seven solar cells 222A to 228A. Seven solar cells 222A to 228A have a fan shape, which are divided by division lines arranged radially from the center of the solar panel 22A, and are cells having an area the same as one another, in which a center angle thereof is adapted to have an angle the same as one another (360 degrees/7).

In this solar panel 22A, the design of the dial 11 is simple, since there are not provided the sub-dial 112 and the scale 113 are not provided thereon. The solar panel 22A is suitable to an electronic timepiece which has a constant transmittance in each region of the dial 11.

In addition, as illustrated in FIG. 11, a solar panel 22B may be used which is divided into eight solar panels 222B to 229B. Eight solar cells 222B to 229B have a fan shape, which are divided by division lines arranged radially from the center of the solar panel 22B, and are cells having an area the same as one another in which a center angle thereof is adapted to have an angle the same as one another (360 degrees/8).

If this solar panel 22B allows eight solar cells 222B to 229B to be connected to one another in series, there is an advantage in that it is possible to further raise the output voltage of the solar panel 22B.

In contrast, when the diameter of the solar panel 22B is the same as that of the solar panel 22A, the area of the solar cells 222B to 229B is smaller than that of the solar cells 222A to 228A, thereby decreasing the power generation current to that extent.

Accordingly, it is preferable to set whether to divide the solar panel into seven solar cells or eight solar cells in overall view of the size of the solar panel in the electronic timepiece 1, the power generation voltage value and the power generation current value of the solar panel which is required for the electronic timepiece 1, the design of the dial 11, the characteristics of the secondary battery 24, and the current consumption of the device which is incorporated in the electronic timepiece 1.

In addition, the solar panel is not limited to those which have the respective solar cells formed in the fan shape. For example, the respective division lines may be set in a direction connecting indexes of three o'clock and nine o'clock in the dial 11, and belt-shaped solar cells may be sequentially arrayed from twelve o'clock to six o'clock. That is, it is advantageous if the solar panel includes solar cells which are divided into seven or eight cells.

The areas of the respective solar cells of the solar panel are not limited to those which have completely the same area as the solar panels 22A and 22B illustrated in FIGS. 10 and 11, and some variations within a predetermined range are allowed. For example, it is advantageous if the area of the individual solar cell falls within ±10% of an average area of all the solar cells.

Similarly, it is preferable that the value calculated by multiplying the area of each solar cell by the transmittance of the region corresponding to each solar cell in the dial is the same as one another. However, some variations within a predetermined range are allowed. For example, it is advantageous if each multiplied value is set to fall within the range of ±10% or less with respect to the average value of the multiplied value.

In addition, in the embodiments, the GPS satellite has been described as an example of the positioning information satellite. However, in addition to the GPS satellite, the positioning information satellite according to the invention may include positioning information satellites which transmit the satellite signal containing the time information of stationary satellites in other Global Navigation Satellite Systems (GNSS) such as the Galileo (EU), the GLONASS (Russia) and the BeiDou (China) or SBAS, and quasi-zenith satellites.

The electronic timepiece according to the invention is not limited to those which include the receiving device 30 receiving the satellite signal of the GPS satellite 100. The invention can also be used in the electronic timepiece having a device requiring large power consumption, such as a device for wireless communication with other electronic devices. In addition, the electronic timepiece is not limited to the wristwatch. For example, the invention can be widely used in a device having a timepiece mechanism which has a device requiring large power consumption and is portably used, such as mobile phones and portable GPS receivers used when climbing.

The entire disclosure of Japanese Patent Application No. 2013-45079, filed Mar. 7, 2013 and of Provisional Application No. 61/770,522, filed Feb. 28, 2013 is expressly incorporated by reference herein.

What is claimed is:

1. An electronic timepiece comprising:
a light-transmitting dial;
a solar panel which is arranged on a side opposite to a display surface of the dial; and
a secondary battery to which power generated by the solar panel is charged,
wherein the solar panel has seven or more solar cells and the solar cells are connected to one another in series.

2. The electronic timepiece according to claim 1,
wherein the solar panel has eight or fewer solar cells.

3. The electronic timepiece according to claim 1,
wherein the respective solar cells are formed in a fan shape from a center to an outer periphery of a surface of the solar panel.

4. The electronic timepiece according to claim 1,
wherein the respective solar cells have the same area as one another.

5. The electronic timepiece according to claim 1,
wherein the respective solar cells have the same value calculated by multiplying the area of each of the respective solar cells by a light transmittance of a region corresponding to each of the respective solar cells in the dial as one another.

6. The electronic timepiece according to claim 1,
wherein the respective solar cells are formed to match a designed shape of the dial.

7. The electronic timepiece according to claim 1, further comprising:
a receiving unit which receives a satellite signal transmitted from a satellite;
a time display unit which displays a time; and
a time correction unit which acquires time information from the received satellite signal and corrects the time to be displayed on the time display unit.
